(19) United States
(12) Patent Application Publication
(10) Pub. No.: US 2005/0143049 A1
(43) Pub. Date: Jun. 30, 2005

(54) Software and hardware enabled satellite detectable distress transmissions from ubiquitous wireless connectivity devices

(76) Inventor: Clare L. Hoke JR., Upland, CA (US)

Correspondence Address: Clare L. Hoke Jr.;Suite 11, 1318 N. Monte Vista Ave., Upland, CA, 91786, US

(21) Appl. No.: 10/746,361

(22) Filed: Dec. 29, 2003

(51) Int. Cl. H04M 11/04

(52) U.S. Cl. 455/404.2

(57) ABSTRACT

The Present Invention is comprised of new hardware and software, to be paired with wireless connectivity devices including Cellular Phones, PCS Digital Cellular Phones, PDA's, Laptop Computers, pagers, GPS auto and handhelds, and remote end user devices, wherein said hardware and software enables said wireless connectivity devices to modulate transmission capabilities to transmit a carrier wave of 406 MHz, and further modulating upon said carrier wave ESN, MIN, SID, ANI information, and further emergency information, including, but not limited to medical information, and GPS location coordinates, to be detected by the COSPAS-SARSAT satellite system, recovered, and transmitted to NOAA for immediate action. Said action by NOAA also including contacting commercial connectivity providers, and medical associations for further information essential to rescue efforts. The above actions being initialized by end users of wireless connectivity devices where regular wireless connectivity is not available. And further, a method whereby secure/emergency/medical information is hidden in plain sight via. dispersing and keying said information amongst web accessible domains, wherein said information is dispersed and lacks any correlation to identity of an individual end user.

### FIELD OF THE INVENTION

The present invention represents hardware and software innovations to be paired with hand held wireless, cellular/PCS digital phones and end user connectivity devices.

### HISTORY OF THE INVENTION

Cellular wireless networks, their legislation and infrastructure, date, decades old, to high level forward thinking business, science, and government. It would be generally dismissive to make such a statement, without giving credit to individual contributors from such vastly differentiated disciplines; however, the resultant efforts of individuals within their respective fields have provided such a positive representation of the diversified disciplines as to make such a statement inarguable.

The ubiquitous nature of wireless cellular phones, and connectivity devices, including PDA's and wireless network connectivity; may be viewed as a market solution to demands that were in waiting for a market solution to fully realize market demands. The applicant respectfully submits that consumer demands, and products from suppliers are currently far from equilibrium, or saturation. The Present Invention is herein proposed in common with the expanding market demands, and societal needs, within the field of the Present Invention.

### SUMMARY OF THE INVENTION

Cellular wireless phones and PCS digital phones are FM radios, some analog (at least until 2008), and some digital in transmission, and further some digital transmissions from networkable devices are encrypted.

With analog systems, the audio is modulated directly onto a carrier wave, like an FM radio where the audio signal (in that case music) is translated to the RF signal. With digital systems, the audio is converted to digitized samples at roughly 8000 samples per second. Digital samples are numbers that represent the time-varying voltage level at specific points in time. These samples (numbers) are now transmitted as digitized 1s and 0s. At the other end, the samples are converted back to voltage levels and “smoothed out” so that the audio signal is again analogous.

Cellular Networks are comprised of Mobile Base Stations or cell sites. The radio signal of each cell site covers a portion of a service area. A service area can have hundreds of cell sites. An additional element, Mobile Switching Centers (MSC) connect the voice path for a call, working with the cell site to determine which radios the mobile phone will use when delivering calls. It interprets the digits entered by the mobile phone user and delivers the call. As the mobile subscriber moves through cell site areas, the MSC reconnects the call to new Mobile Base Stations. The MSC provides the path to the public switched telephone network, for delivering calls to landline phones or to long-distance numbers.

However, the Mobile Base Stations or cell sites cannot be farther away from subscriber's portable phones (duplex channel, FM radio transmitters and receivers) than the distance that the portable phones are able to transmit. Cellular systems in the United States operate in the 824 MHz to 894-MHz frequency bands; PCS operates in the 1850-MHz to 1990-MHz bands. In rural areas, where there are not enough subscribers to warrant a cell tower, or in wilderness areas, cellular phones do not work.

This presents a problem for individuals who bring cell phones into wilderness and rural areas for precautionary and safety reasons. The odds are that such individuals will not benefit from their cell phones if they venture very far from urban regions. In case of emergency, the cell phones cannot function when they are out of range of cell towers.

As of Jul. 1, 2003 it has become legal for civilians within the United States to purchase a 406 MHz Personal Locator Beacon (PLB). Radio frequencies which are operable within the 406 MHz spectrum have been protected within the United States, for military/defense use, but viable for civilian use world wide for some time. This frequency is monitored world wide for distress signals by low level, stationary orbit satellites. PLB's are generally 5 watts in power, are provided in waterproof containers, with batteries that guarantee either 24, or 48 hour operation time, and currently average $700 MSRP.

A digital alert on 406 MHz is picked up by low earth orbiting satellites that can determine a location of a transmission source using Doppler shift technology. Generally, within the continental U.S. most users can expect their location will be determined within 30 minutes. Quoting from the FCC's webpage:

“PLBs transmit distress signals on 406 MHz which is an internationally recognized distress frequency to the COSPAS-SARSAT satellite system. This system is an international program to which 36 nations belong. In the United States the 406 MHz signal is monitored by the National Oceanic and Atmospheric Administration (NOAA) and the Air Force Rescue Coordination Center (AFRCC). Once a signal is received, the satellites can “fix” on the signal using a Doppler Shift location method, or, when a PLB is hooked up to a GPS, the GPS coordinates can be instantly transmitted without waiting for an orbiting satellite. The signal is then relayed to a Local User Terminal (LUT). These small satellite tracking stations are located all over the world and provide the link between the satellites and the Mission Control Center (MCC), which in the USA is NOAA. This signal is then passed on to the Air Force to begin the Search and Rescue procedures.

Each PLB is equipped with a unique identifying code which is a 15 digit alpha-numeric code. This code is transmitted in the electronic burst to the satellites and is linked to a computer database maintained by NOAA to provide your name, address, phone number and any pertinent information such as medical problems, to Search and Rescue personnel.”

The Present Invention places the 406 MHz, or similar frequency, as monitorable by satellites, transmittable from wireless cellular phones, and connectivity devices, including PDA's and wireless network connectivity devices. Cellular phones, wireless PDA's, computers, and wireless connectivity devices, are not generally regarded as satellite interfaces, or transmitters, however, low power radio frequency devices, with alterations of hardware and software under the scope of the Present Invention shall provide rescue/emergency, services in a novel manner.

Software within said wireless connectivity devices will modulate said devices to transmit on satellite monitored emergency frequencies. In a variation of the present invention, said wireless connectivity devices (WCD's) may be equipped with GPS systems, transmitting the location of the WCD, on the 406 Mhz frequency as well.

### BRIEF SUMMARY OF THE INVENTION

Accordingly, several objects and advantages of the present invention include:
(a) saving lives
(b making ubiquitous, low power radio devices adaptable to novel rescue/emergency roles, outside of the range of cellular coverage.
(c) expanding the spectrum available to low power cellular devices to include emergency satellite monitorable frequencies.
d) improved information distribution between governmental rescue agencies and commercial connectivity providers, and medical organizations.
e) method of securing personal/emergency/medical information while providing access to Rescue Management Services.

### BRIEF DESCRIPTION OF DRAWINGS

FIG. 1 shows Rescue Management Services receiving emergency/rescue information, from resources previously incapable of transmission as detectable by satellites monitoring emergency broadcast frequencies; and Rescue Management Services further contacting commercial wireless connectivity providers, and medical associations to gather information essential to rescue efforts.

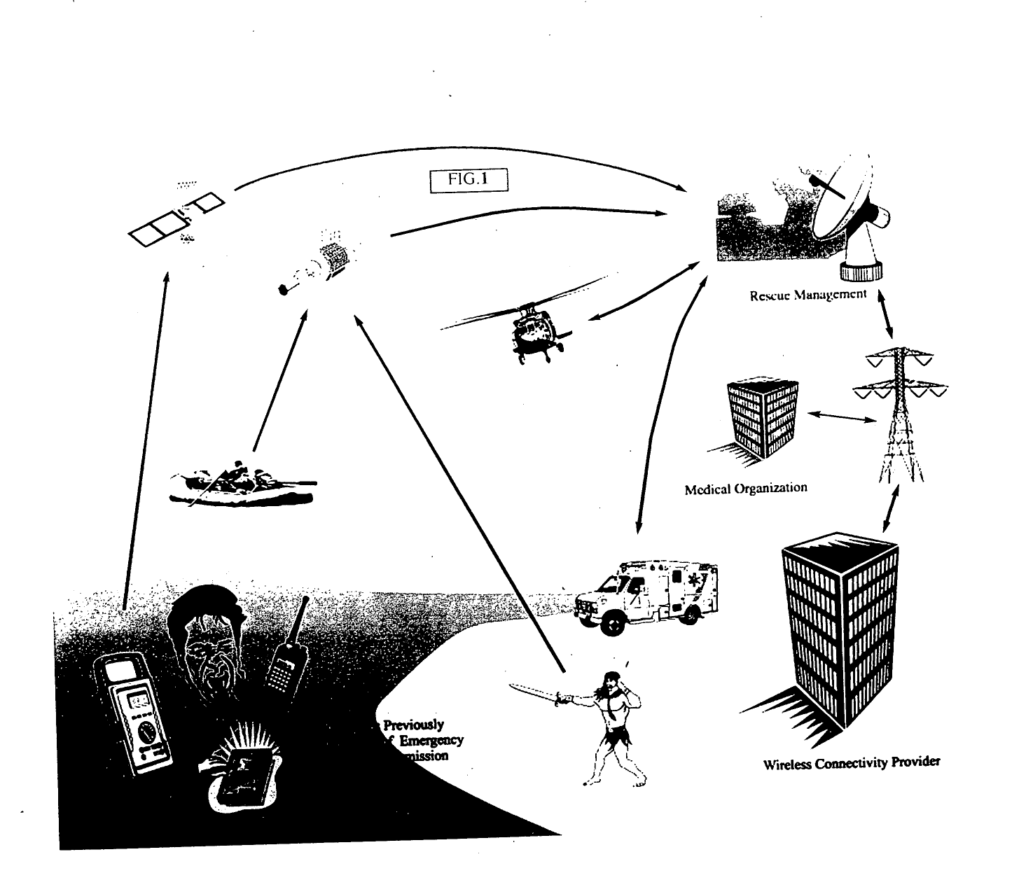

FIG. 2 depicts a wireless connectivity end user device including but not limited to a cellular phone, PCS digital phone, pager, PDA, pager, GPS auto or hand held, laptop computer, modulating from standard wireless transmission frequencies to transmit information upon emergency/rescue satellite monitored frequencies.

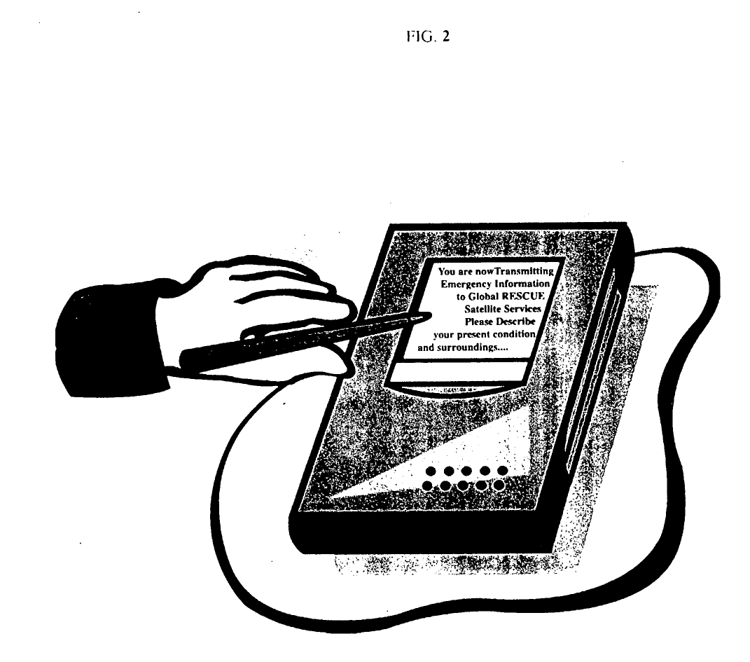

FIG. 3 shows a wireless connectivity device, in this instance a cell phone, modulating to transmit at 406 MHz, and sending information to be monitored and relayed via. satellite, to Rescue Management Services, and further a method whereby secure/emergency/medical information is hidden in plain sight via. dispersing and keying said information amongst web accessible domains, wherein said information is dispersed, and lacks any correlation to the identity of any individual end user.

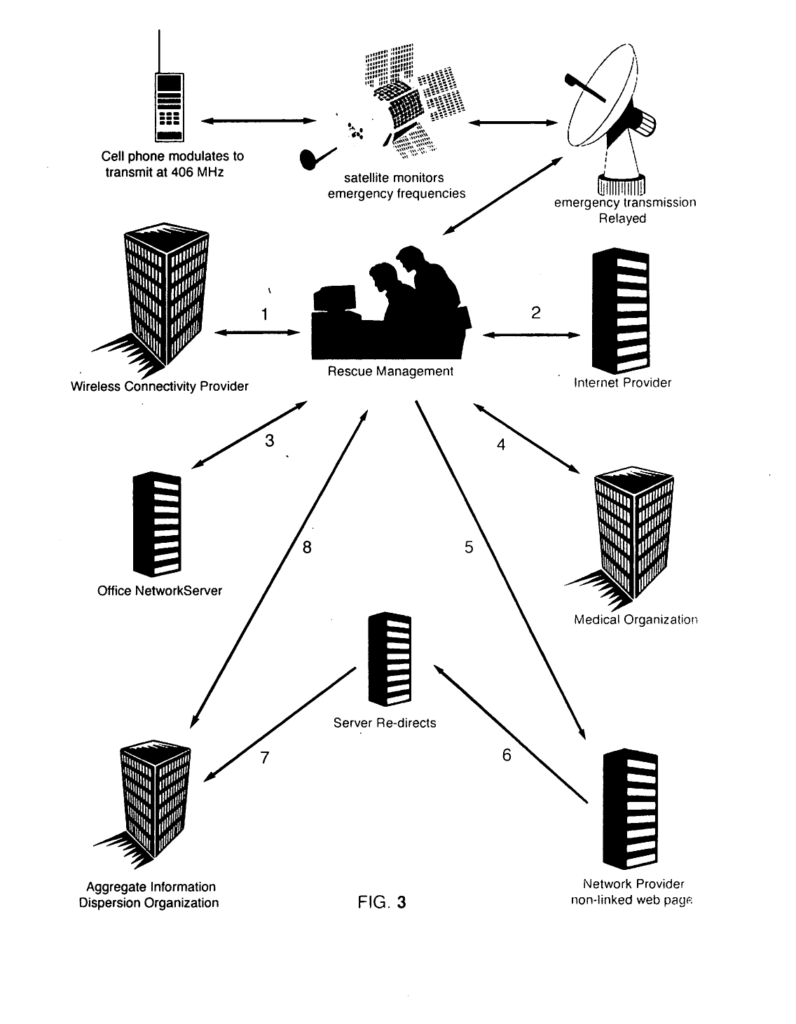

### DESCRIPTION OF THE PREFERRED EMBODIMENTS

Cellular analogue phones, cellular digital phones, PCS digital phones, end user devices, end user connectivity devices, GPS auto and handhelds, pagers, laptop computers, and computers are bound by law to provide wireless services within specific frequency/power constraints. These constraints, provided by law have been enacted and enforced for public benefit, by governmental jurisdictions. Ultimately, within free societies, constraints provided to military concerns are granted with analysis of benefits to citizens. The above premise must be assessed against living, developing, societal demands and technologies.

Presently, cellular phones are required to supply GPS locations of callers to police/emergency services, when individuals or organizations access the 911 networks. Cellular/PCS providers currently are expected to achieve market saturation of GPS capable phones by the year 2005. However, the scope of the Present Invention embraces devices which are also not GPS capable.

To function, Cellular analogue phones, cellular digital phones, PCS digital phones, end user devices, end user connectivity devices, laptop computers, and computers hereafter referred to as wireless connectivity devices (WCD's) must be within close proximity to a receiving network, cellular antenna, or relay, hereafter referred to as a receiver. Wireless connectivity devices have been designed with limited transmission power, and are capable of transmitting a few miles at most, depending on line of sight with receiver stations; with the exception of certain computer wireless systems which may piggyback transmissions from laptop to laptop, effectively extending the range available to a receiver network. For the above wireless systems to work, receivers must be placed within the range of wireless connectivity devices, in an overlapping array.

The Present Invention is comprised of hardware and software which enables ubiquitous WCD's to be useful within and without of wireless regular connectivity coverage areas. In the preferred embodiment of the Present Invention end users may enter a specific code to initialize the end users WCD for rescue purposes. The fact that 911 is well established as a distress code suggests using this code with a additional integers to instigate rescue operations outside of receiver range of Mobile Base Stations. The actual code to be utilized and promoted for public awareness has not been established, however in the present example of the Preferred Embodiment of the Present Invention, an end user first attempts to dial 911, from his WCD and hits send. When the end user determines that he is out of range of regular wireless service, the end user may reassess the seriousness of the his predicament. The public is well informed that 911 is for emergency use only, however to prevent false alerts, in one variation of the Present Invention end users are notified in advance that by employing their WCD under the scope of the Present Invention, end users will incur a fee. In the present example, our end user regards the fee as justifiable in relation to the level of assistance he requires. The end user enters 911 GPS (911477) on his WCD, which initializes a chain of events.

The WCD in the present example has novel hardware and software improvements wherein entering the code of 911 GPS, software within the device modulates the WCD's transmission frequency to 406 MHz. In the preferred embodiment of the Present Invention the device also switches the amplitude of transmission to its highest level. In a variation of the Present Invention the device assesses its available battery capacity and adjusts the output transmittal level so that the device may maintain ninety minutes of transmission, at a given output level, as determined by residual battery capacity. Failing the ability to sustain beacon transmission for ninety minutes, the device, alternately goes into burst mode, and puts out as much power as possible, for as long as possible.

The transmission from the end user WCD transmits a carrier frequency of 406 MHz, and further modulates upon the carrier signal individual WCD specific information. WCD's have Automatic Number Identification (ANI) technologies in place, and the unique portable end user devices serial number will be registered in advance, much the way Personal Locator Beacons are currently. NOAA, as well as commercial connectivity providers will be accessed, for previously recorded emergency information. The FCC has ruled that cell-phone providers must equip their phones with GPS receivers by October 2001. Within the scope of the Present Invention, GPS coordinates ascertained from WCD's will be modulated upon the 406 MHz carrier signal of said WCD's along with said ANI information. WCD devices lacking GPS abilities may also be capable of modulating transmissions to broadcast within the 406 MHz band, however this expands the level of difficulty of locating said WCD within the domains of Rescue, and Doppler technologies.

Within the scope of the Present Invention the hardware modifications to existing; and as yet marketed WCD's are vast. While WCD's in present form are capable of providing enough output power for life saving, results (after being modified to transmit upon emergency frequencies): battery life, antenna assemblies and electronic transmission headroom are substantial regions of marketable device improvement for the purposes of the delineated invention. Antenna assemblages are the first effective improvements for devices which are intended for enhanced worldwide stability and transmission recognition. Improved battery life provides solutions to existing market needs. It is suggested that within the scope of the Present Invention WCD's have headroom in excess of standard operational safe RF standards. This headroom requirement being available, optionally, against the day of need, when an end user decides to make the informed decision, and accepts the responsibility, of initializing a higher than normal powered RF device at arms length or greater, as preferable against desperate circumstance. However, the COSPAS-SARSAT satellite system is capable of detecting 406 MHz transmissions of current, low cellular and PCS power levels.

Within the scope of the Present Invention the software improvements to existing; and as yet marketed WCD's are innumerable. As the Present Invention embraces and enables multiple types of devices including cellular phones, PCS digital phones, PDA devices, Laptop Computers, Medical Devices, Pagers, wireless digital computational capable devices, Remotes, Bluetooth enabled devices, to modulate to satellite identifiable frequencies, imprint device specific information including serial numbers and manufacture information, user information, end user emergency information, end user travel plans, and GPS information upon a an Internationally identifiable distress carrier frequency for satellite reception. Said software further being capable of initializing protocols for distress broadcast wherein, said software upon said end user devices provides methods for, including but not limited to: carrier wave modulation, antenna modular switching for 406 MHz deployment, battery life assessment and management, accessing device transmission headroom for emergency usage, carrier signal modulation to transmit GPS information and device ANI information, and further digitized voice and text information, as provided by end users within the scope of the Present Invention.

Currently within the United States, the National Oceanic and Atmospheric Administration (NOAA) is the Mission Control Center (MCC), and provides Rescue Management for Rescue operations initialized by transmissions detected by the COSPAS-SARSAT satellite system. NOAA may determine that its efforts should not be directed to recording and correlating ANI information for end user devices, contact information for end users, emergency medical information for individual end users, additional end user product information, and further information as may be determined useful to rescue operations. In this instance there are divergent solutions to solve the problem of information storage, validation and retrieval.

The simplest solution includes placing software upon end user devices wherein medical and contact information may be stored. In this instance an end user may enter, and save information into a device, interfacing via. window environment, or for devices lacking such interfaces, via. Bluetooth, or similar connectivity protocol. In the Preferred Embodiment of the Present Invention said end user WCD's will have hardware and software in place wherein said entered and saved medical and contact information may only be accessed when the end user device is initialized for 406 MHz emergency broadcast. In this instance said end user device then changes its transmission broadcast frequency to 406 MHz, accesses the end users personal emergency information file, and modulates the information upon the 406 MHz carrier wave, along with GPS information (if so equipped) and device ANI information. Above said information then being detected by the COSPAS-SARSAT satellite system, recovered, and transmitted to NOAA for immediate action.

The 406 MHz emergency broadcast spectrum in consort with the COSPAS-SARSAT satellite system, has been designed for optimal stability in mind. However as technologies improve over time, such reliability will be enhanced, and features may be added to technological systems without endangering stability. In the preferred embodiment of the Present Invention, as technological/political advances allow, it will be feasible within the scope of the Present Invention that end users will further enter real time digitized information upon said end users WCD's including keyed in text messages, digitized audio, digitized voice messages, and digitized visual information, such as a picture of terrain, as may greatly assist rescue efforts.

In a variation of the Present Invention, end user emergency information may be validated and stored by the end users wireless connectivity provider. Cellular and PCS providers associate an Electronic Serial Number (ESN), a unique 32-bit number programmed into the phone when it is manufactured—a Mobile Identification Number (MIN), a 10-digit number derived from the phone's number System Identification Code (SID), and a unique 5-digit number that is assigned to each carrier by the FCC; for every call that is made. Within the scope of the Present Invention, upon the COSPAS-SARSAT satellite system detecting a 406 MHz signal, NOAA requests a search of commercial carrier networks for matching ANI, ESN, MIN, SID, information, and corresponding digital files of emergency information, only made accessible in the event of an emergency, wherein said emergency information is initialized by a 406 MHz emergency broadcast from an end users wireless device.

In a further variation of the Present Invention, end user emergency information may be dispersed to, and retrievable from specific medical organizations, so as to provide an additional layer of security for the purposes of maintaining end user privacy. In the previous example, said commercial wireless connectivity providers may associate a particular medical group with device specific ANI information, wherein after being contacted by NOAA, said commercial wireless connectivity providers may access the associated medical group's contact information, requesting that the particular medical group contact NOAA directly, or that NOAA contact the medical group to retrieve any pertinent medical, or further contact information.

Within the scope of the Present Invention, is suggested a novel method for storing personal medical information, so as to keep such information accessible to Rescue Management services worldwide. In a variation of the Present Invention, individual medical information is published upon the World Wide Web, from several geographically dispersed servers as individual web pages, or web accessible documents. However these web accessible documents do not have the identities of individuals associated with the documents. In this manner, private information may be hidden in plain sight, as someone inspecting the domain of such a server would not be able to access correlative information associating individuals with emergency/medical information, in that correlative information is reserved off line within particular organizations.

In this variation of the Present Invention, the end user who initiates a 406 MHz emergency broadcast from an end user wireless device, transmits ESN, MIN, SID, ANI, information, as transmitted upon said carrier wave, whereby, Rescue Management contacts the end users wireless connectivity provider, through secure channels and protocols, sending information or, a digitized copy of the transmission. The wireless connectivity provider verifies the devices signature; as it does this process for every call transferred within the domain of said wireless connectivity provider. Having verified the emergency nature and contact with Rescue Management, the wireless connectivity provider then provides information which is accessible only when required by verified Rescue Management agencies. This information may include the address of said un-correlated web document, or further may provide an address and access code for a further organization to contact, whereby correlative information may be further, and further removed from any specific domain or organization, with the addition of further domains and organizations involved. That each organization involved represents a highly responsible organization, who must verify its identity between parties of responsible organizations, further enhances security under the present invention. As each said organization within the structure of dispersed access has securities and protocols in place to defend information, the dispersion of vital information, across organizations and platforms, in consort with apparent random publication of emergency information upon secure servers, provides an unparalleled level of security and access, which is novel to the present invention.

The above example is novel to the present invention in that the level of diligence and public storage of vital information by responsible service organizations currently does not exist in consort with Rescue Management. Variations of the above example may span from an individual posting a upon a third party server, along with a personal web page, a page which is not linked to said personal web page, which contains emergency information, but may only be accesses by knowing the IP. address. A further variation would include the domain of a commercial service, which posts emergency information, without any discernable correlation to specific individuals.

A further expansion of the Present Invention embraces the opportunity of group, or aggregate purchases of storage space across the domains of multiple Internet Service Providers, Network Providers Connectivity Providers, Digital Content Providers, Wireless Connectivity Providers, Servers, and Routers, wherein the identities of individuals may not be associated with specific emergency/medical/secure information, as funds may not be traced to specific domains, from specific individuals, as said storage space is purchased in aggregate, so as to disperse the “money trail” of individuals, for legitimate purposes.

The Present Applicant respectfully submits that presently, cellular phones, PCS digital phones, PDA devices, Laptop Computers, Medical Devices, Pagers, Remotes, and Bluetooth enabled devices are not enabled for transmission within the 406 MHz band, for the purpose of rescue, via. satellite detection; outside of the range of existing, or traditional wireless coverage. The present Invention is therefore presented in the interest of the preservation of life, and the mitigating of suffering, wherever applicable.

1) Hardware and Software modifications to wireless connectivity devices (WCD's) including Cellular Phones, PCS Digital Cellular Phones, PDA's, Laptop Computers, pagers, GPS auto and handhelds, and wireless remote end user devices, wherein:
means of end users initializing said wireless connectivity devices for emergency transmission by entering into said connectivity device a specific, pre-determined code,
means of said specific, pre-determined code triggering modulation of transmission frequency of said wireless connectivity devices to transmit a carrier wave at 406 MHz,
means of storing upon said wireless connectivity device digitized information, including but not limited to the Electronic Serial Number (ESN) of said end user device, a Mobile Identification Number (MIN), a System Identification Code (SID), Automatic Number Identification (ANI) information, emergency contact information, emergency medical information, specific addresses of contacts to access emergency contact information, specific addresses of contacts to access emergency medical information, keys to access emergency medical information, current GPS coordinates,
means of accessing upon said wireless connectivity device digitized information, including but not limited to the Electronic Serial Number (ESN) of said end user device, a Mobile Identification Number (MIN), a System Identification Code (SID), Automatic Number Identification (ANI) information, emergency contact information, emergency medical information, specific addresses of contacts to access emergency contact information, specific addresses of contacts to access emergency medical information, keys to access emergency medical information, current GPS coordinates,
means of modulating upon said carrier wave during transmission, digitized information, including but not limited to: the Electronic Serial Number (ESN) of said end user device, a Mobile Identification Number (MIN), a System Identification Code (SID), Automatic Number Identification (ANI) information, emergency contact information, emergency medical information, specific addresses of contacts to access emergency contact information, keys to access emergency medical information, specific addresses of contacts to access emergency medical information.

2) Hardware and Software modifications to wireless connectivity devices in accordance with claim 1, and further,
means of modulation upon said carrier wave, real time digitized end user input, including keyed in text messages, digitized audio, digitized voice messages, and digitized visual information.

3) Hardware and Software modifications to wireless connectivity devices (WCD's) in accordance with claim 2, and further,
means of storing within said WCD's, the digitized addresses and contact information of specific resources to be contacted in case of emergency as initiated by said WCD's, wherein,
upon said WCD's being triggered to transmit a carrier wave of 406 MHz, said WCD's modulate said digitized addresses and contact information of specific resources, to be transmitted upon said carrier wave, and further,
upon detection of said carrier wave by satellite systems, including but not limited to the COSPAS-SARSAT satellite system, said digitized addresses and contact information of specific resources are recovered, and transmitted to Rescue Management and further,
said rescue management then contacting said digitized addresses of specific resources for information beneficial to rescue operations.

4) Hardware and Software modifications to wireless connectivity devices (WCD's) in accordance with claim 3, wherein,
the digitized addresses and contact information of specific resources to be contacted in case of emergency as initiated by said WCD's, include commercial connectivity providers and medical organizations which provide storage of emergency information for individual end users of specific WCD's.

5) Hardware and Software modifications to wireless connectivity devices (WCD's) in accordance with claim 4, wherein,
said Rescue Management contacts said connectivity providers based upon said WCD's ESN, MIN, SID, ANI, as transmitted upon said carrier wave, whereby,
Rescue Management is granted access to emergency information stored within the domains of said connectivity providers, as indexed by said ESN, MIN, SID, ANI, and further,
Rescue Management determines from said connectivity providers, the location of additional emergency information, outside of the domains of said connectivity providers, to be accessed by Rescue Management,
said additional emergency information being dispersed within the domains of multiple organizations, and accessible via. the initialization of verified transmissions of specific end user WCD's upon emergency broadcast frequencies.

6) In low orbit satellite systems, including, but not limited to the COSPAS-SARSAT satellite system;
step wherein said satellite systems monitor pre-determined emergency radio frequencies for transmissions of carrier wave signals within specific band spectrums,
step wherein said satellite systems receive software upgrades whereby,
step for said software upgrades expanding assessment of said carrier wave signals to include further recognition and analysis of digitized information modulated upon said carrier signals, including WCD, ESN, MIN, SID, ANI, information,
step for assessment of said digitized information modulated upon said carrier signals,

7) In low orbit satellite systems, in accordance with claim 6,
step wherein said satellite systems monitor pre-determined emergency radio frequencies for transmissions of carrier wave signals within specific band spectrums,
step wherein said satellite systems receive software upgrades whereby,
step for said software upgrades expanding assessment of said carrier wave signals to include further recognition and analysis of digitized information modulated upon said carrier signals,
step for assessment of said digitized information modulated upon said carrier signals,
step for assessment of real-time digitized information, modulated upon said carrier wave, said real-time information including voice, text, GPS, and photographic information.

8) Low orbit satellite systems, in accordance with claim 7, wherein,
said low orbit satellite systems assesses said information modulated upon said carrier signals, said low orbit satellite systems extracting digitized information, including specific addresses and contact information whereby,
Rescue Management associated with said low orbit satellite systems contact and transfer information based upon said information modulated upon said carrier signals, to access end user information as recorded and stored within the domains of commercial Wireless connectivity providers.

9) Low orbit satellite systems, in accordance with claim 8, wherein,
said low orbit satellite systems assesses said information modulated upon said carrier signals, said low orbit satellite systems extracting digitized information, including specific addresses and contact information whereby,
Rescue Management associated with said low orbit satellite systems contact and transfers information based upon said information modulated upon said carrier signals, to access end user information as recorded and stored within the domains of Medical Establishments, Internet Providers, Network Providers, Connectivity Providers, Digital Storage Providers, Servers, Routers, and Aggregate Information Dispersion Organizations

10) Low orbit satellite systems, in accordance with claim 9, wherein,
Rescue Management Services, associated with said low orbit satellite systems, is provided all necessary rescue information based upon said information as stored and transferred from end users wireless connectivity devices and modulated upon said carrier signal.

11) Within the domains of Wireless Connectivity Providers, services whereby, said Wireless Connectivity Providers, provide:
step for access from Rescue Management Services,
step for verification of said Rescue Management Services,
step for validation of transmissions from specific end user Wireless Connectivity Devices (WCD's), whereby said transmissions are relayed from said Rescue Management Services,
step for validation of transmissions from specific end user WCD's, whereby information from said transmissions are relayed from said Rescue Management Services,
step for said Wireless Connectivity Providers, granting access to previously stored emergency information, as indexed by said validated transmissions from specific end user WCD's, said transmissions being detected by said Rescue Management Services from said end user WCD's modulating to transmit upon satellite detectable emergency frequencies.

12) Within the domains of Rescue Management Services,
step wherein said Rescue Management Services receives transmissions from end user Wireless Connectivity Devices (WCD's) upon emergency satellite frequencies,
step wherein said Rescue Management Services contacts and verifies communication with the regular Wireless Connectivity Providers for said WCD's,
step wherein said Wireless Connectivity Providers, validate contact with Rescue Management Services.
step wherein said Rescue Management Services transfers information from said WCD's to said regular Wireless Connectivity Providers,
step wherein said Rescue Management Services, transfers a copy of said transmissions from end user WCD's, to said Wireless Connectivity Providers,
step wherein said Wireless Connectivity Providers, validate WCD, ESN, MIN, SID, ANI, information for end users WCD's,
step wherein said Wireless Connectivity Providers, deny or confirm said validation of said information for end users WCD's, to said Rescue Management Services.

13) Within the domains of Rescue Management Services, in accordance with claim 12,
step wherein said Rescue Management Services receives transmissions from end user Wireless Connectivity Devices (WCD's) upon emergency satellite frequencies,
step wherein said Rescue Management Services contacts and verifies communication with the regular Wireless Connectivity Providers for said WCD's,
step wherein said Wireless Connectivity Providers, validate contact with Rescue Management Services.
step wherein said Rescue Management Services transfers information from said WCD's to said regular Wireless Connectivity Providers,
step wherein said Rescue Management Services, transfers a copy of said transmissions from end user WCD's, to said Wireless Connectivity Providers,
step wherein said Wireless Connectivity Providers, validate WCD, ESN, MIN, SID, ANI, information for end users WCD's,
step wherein said Wireless Connectivity Providers, deny said Rescue Management Services access to emergency information based upon said WCD, ESN, MIN, SID, ANI, information from end users WCD's
step wherein said Wireless Connectivity Providers, enable said Rescue Management Services access to emergency information based upon said WCD, ESN, MIN, SID, ANI, information from end users WCD's
step wherein said Rescue Management Services extract from said Wireless Connectivity Providers, all required emergency information.

14) Within the domains of Rescue Management Services, in accordance with claim 13,
step wherein said Rescue Management Services extract from said Wireless Connectivity Providers, all required emergency information to access secondary domains to retrieve additional required emergency information.

15) Within the domains of Rescue Management Services, in accordance with claim 14,
step wherein said Rescue Management Services extract from said Wireless Connectivity Providers, all required emergency information to access secondary domains to retrieve required emergency information, and further,
step wherein said Rescue Management Services extract from said Wireless Connectivity Providers, all required emergency information to access additional third, fourth, fifth, domains ad infinitum, to retrieve required emergency information.

16) Within a globally based digital telecommunication, cable, fiber optic, satellite based network having an infrastructure of, Internet Service Providers, Network Providers Connectivity Providers, Digital Content Providers, Wireless Connectivity Providers, Servers, and Routers,
step wherein emergency and medical information, for individuals is dispersed within the domains of said Internet Service Providers, Network Providers Connectivity Providers, Digital Content Providers, Wireless Connectivity Providers, Servers, and Routers, upon said globally based digital telecommunication, cable, fiber optic, satellite based network whereby,
step wherein said emergency information for individuals is readily accessible from standard web browsers, using IP addresses,
step wherein said emergency information contains no correlative information regarding the identity of said individuals,
step wherein said emergency information is accessed through the domains of individual said Internet Service Providers, Network Providers Connectivity Providers, Digital Content Providers, Wireless Connectivity Providers, Servers, and Routers,
step wherein said emergency information is accessed through the domains of multiple said Internet Service Providers, Network Providers Connectivity Providers, Digital Content Providers, Wireless Connectivity Providers, Servers, and Routers, each containing access codes and IP addresses for additional domains and resources,
step wherein said Internet Service Providers, Network Providers Connectivity Providers, Digital Content Providers, Wireless Connectivity Providers, Servers, and Routers, provide capacity within the domains of said respective Internet Service Providers, Network Providers Connectivity Providers, Digital Content Providers, Wireless Connectivity Providers, Servers, and Routers, for the dispersion of secure/emergency/medical information.

17) Within a globally based digital infrastructure as described within claim 16,
step wherein said Internet Service Providers, Network Providers Connectivity Providers, Digital Content Providers, Wireless Connectivity Providers, Servers, and Routers, provide capacity within the domains of said respective Internet Service Providers, Network Providers Connectivity Providers, Digital Content Providers, Wireless Connectivity Providers, Servers, and Routers, for the storage of said emergency information.

18) Within a globally based digital infrastructure as described within claim 17,
step wherein said Internet Service Providers, Network Providers Connectivity Providers, Digital Content Providers, Wireless Connectivity Providers, Servers, and Routers, provide capacity within the domains of said respective Internet Service Providers, Network Providers Connectivity Providers, Digital Content Providers, Wireless Connectivity Providers, Servers, and Routers, for the dispersion, storage, and retrieval of said emergency information, based upon grouped policies of expenditures from individuals, so as to make the storage expenditures of individuals non-correlative to the identities of said individuals.

19) Within a globally based digital infrastructure as described within claim 18,
step, wherein access to secure/emergency/medical information as secured within the domains of said Internet Service Providers, Network Providers Connectivity Providers, Digital Content Providers, Wireless Connectivity Providers, Servers, and Routers; is initialized by transmissions of wireless connectivity devices (WCD's) including Cellular Phones, PCS Digital Cellular Phones, PDA's, Laptop Computers, pagers, GPS auto and handhelds, and wireless remote end user devices.

20) Within a globally based digital infrastructure as described within claim 19,
step, wherein said access to secure/emergency/medical information as secured within the domains of said Internet Service Providers, Network Providers Connectivity Providers, Digital Content Providers, Wireless Connectivity Providers, Servers, and Routers; is initialized by transmissions of wireless connectivity devices (WCD's) including Cellular Phones, PCS Digital Cellular Phones, PDA's, Laptop Computers, pagers, GPS auto and handhelds, and wireless remote end user devices, as transmitted upon global emergency satellite monitorable frequencies, wherein,
said WCD's are modulatable from standard wireless connective frequencies, to said satellite monitorable frequencies.
